(19) United States
(12) Patent Application Publication
(10) Pub. No.: US 2009/0231495 A1
(43) Pub. Date: Sep. 17, 2009

(54) IMAGE PROJECTOR WITH MULTIPLE IMAGERS

(75) Inventors: Xiaodong Xun, Schaumburg, IL (US); Zili Li, Barrington, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/046,989

(22) Filed: Mar. 12, 2008

(51) Int. Cl. H04N 9/31

(52) U.S. Cl. 348/744; 348/E09.025

(57) ABSTRACT

Disclosed are a system and method for microprojection that uses multiple imagers to produce a high resolution output image. Light created for use by the microprojector is split by a polarization-sensitive element into a number of beams. Each polarized beam is then sent to an imager. Each imager modulates the light beam to produce a portion of the final image. Another polarization-sensitive element directs the individual image portions through a projection lens system so that when they are projected, the individual image portions tile together into a seamless projected image. This technique uses essentially all of the original light, doubling the lighting efficiency of previous devices. Because the height of the individual imagers is smaller than the height of a monolithic imager, they can fit into a very thin device. The combined image has a resolution equal to the sum of the resolutions of the individual imagers.

### FIELD OF THE INVENTION

The present invention is related generally to projection of optical images, and, more particularly, to optical-image projectors subject to space limitations.

### BACKGROUND OF THE INVENTION

A trend in personal portable devices (such as cell phones and personal digital assistants) is to add new features while keeping the devices small. Many of the new features, such as photograph sharing and video downloading, depend upon a high resolution, easy-to-read display screen. However, manufacturers cannot simply keep increasing the size of their display screens because that would eventually run counter to the desire to keep the devices small and portable.

Recently, “microprojectors,” a new category of display device, have been designed to address this conflict between greater display area and smaller device size. An image, either still or moving, is projected from the device onto a convenient surface (e.g., a projection screen or an office wall). The maximum size of the image is then effectively constrained by the amount of available wall space rather than by the size of the device itself. Using a microprojector-equipped device, several people can simultaneously view a photograph, for example, or review a full page of text, neither of which can be readily done with even the largest displays on current personal portable devices.

Promising as they are, microprojectors raise new headaches when engineers attempt to fit them into personal portable devices. While the overall size of the projected image may be effectively unlimited, expanding the image size is of little use if the resolution of the projected image is severely constrained. What customers want is a projected image that is both larger overall and has much greater resolution than a device's display screen. But, generally, the overall size of a microprojector grows with the amount of resolution it provides. This is especially true when a microprojector uses a microdisplay imager as its image source. The trend toward very thin personal portable devices renders it a challenge to fit in a microprojector that provides usefully high resolution.

Power use is another challenge. By its nature, a microprojector uses a significant amount of power to light a large display area. In addition, microprojectors usually use proven liquid-crystal displays which only work with linearly polarized light. Light created for use by the microprojector is first sent through a polarizer, a component that discards about half of the original light and thus discards about half of the power. Reducing the physical size of the microprojector exacerbates the power problem because the optics in microprojectors become less power-efficient as they become smaller. Designers of battery-based personal portable devices are already concerned about their power budgets and look askance at any new feature that threatens to reduce the utility of the device by reducing how long the device can operate between charges.

### BRIEF SUMMARY OF THE INVENTION

The above considerations, and others, are addressed by the present invention, which can be understood by referring to the specification, drawings, and claims. According to aspects of the present invention, a microprojector uses multiple imagers to produce a high resolution output image and avoids the use of very small imager optics with their lowered efficiency.

Light created for use by the microprojector is split by a polarization-sensitive element into a number of beams. Each polarized beam is then sent to an imager. Each imager modulates the light beam to produce a portion of the final image. Another polarization-sensitive element directs the individual image portions through a projection lens system so that when they are projected, the individual image portions tile together into a seamless projected image. This technique uses essentially all of the original light, doubling the lighting efficiency of previous devices.

Because the height of the individual imagers is smaller than the height of a monolithic imager, they can fit into a very thin device. The combined image has a resolution equal to the sum of the resolutions of the individual imagers. In some embodiments, for example, two imagers are placed side by side. One imager produces the top half of the combined image, and the other imager produces the bottom half. When the two halves are combined, the combined image has a horizontal resolution equal to that of each imager and a vertical resolution equal to the sum of the vertical resolutions of the individual imagers.

### BRIEF DESCRIPTION OF THE SEVERAL VIEWS OF THE DRAWINGS

While the appended claims set forth the features of the present invention with particularity, the invention, together with its objects and advantages, may be best understood from the following detailed description taken in conjunction with the accompanying drawings of which:

FIG. 1 is an overview of a representative environment in which aspects of the present invention can be practiced;

FIG. 2 is a simplified schematic view of an exemplary microprojector with two transmissive imagers;

FIG. 3 is a flowchart of an exemplary embodiment of the present invention;

FIG. 4 is a schematic of an arrangement for directing polarized light toward two transmissive imagers; and

FIG. 5 is a simplified schematic view of an exemplary microprojector with two reflective imagers

### DETAILED DESCRIPTION OF THE INVENTION

Turning to the drawings, wherein like reference numerals refer to like elements, the invention is illustrated as being implemented in a suitable environment. The following description is based on embodiments of the invention and should not be taken as limiting the invention with regard to alternative embodiments that are not explicitly described herein.

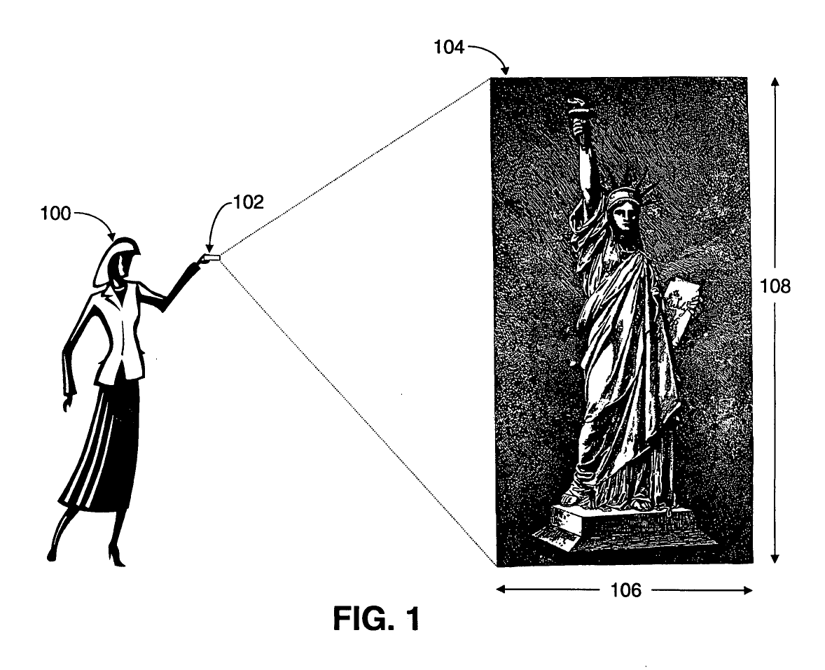

In FIG. 1, a user 100 is projecting an image 104 from her personal portable device 102. The image 104 could be, for example, a photograph, a video, or a computerized display from a word processor or an Internet browser. The image 104 may be projected onto a screen or even onto a wall or ceiling. By projecting the large, high resolution image 104 rather than presenting it on a (necessarily small) display screen of her personal portable device 102, the user 100 can invite others to share the image 104 with her.

The resolution of a digital image is defined as the product of its horizontal resolution and its vertical resolution. Resolution is measured in number of pixels. In FIG. 1, the image 104 has a horizontal resolution “Rx.” Rx measures the number of addressable pixels in the horizontal direction and is indicated by 106 in FIG. 1. The vertical resolution “Ry” counts addressable pixels in the vertical direction and is indicated by 108. Note that here “horizontal” and “vertical” are merely convenient, and conventional, names for the two dimensions of a planar image, and are not confined to orientations taken with respect to the direction of gravity.

In a projector, an “imager” is a device that modulates light in order to imprint image information into a projected light beam. Generally, the resolution of a projected image is equal to the resolution of the imager that creates the image. Traditionally, including within the personal portable device 102 an imager that provides acceptable resolution for the projected image 104 makes the personal portable device 102 both thick and bulky. The present invention addresses this issue by allowing a small and thin personal portable device 102 to project a large, high resolution image 104.

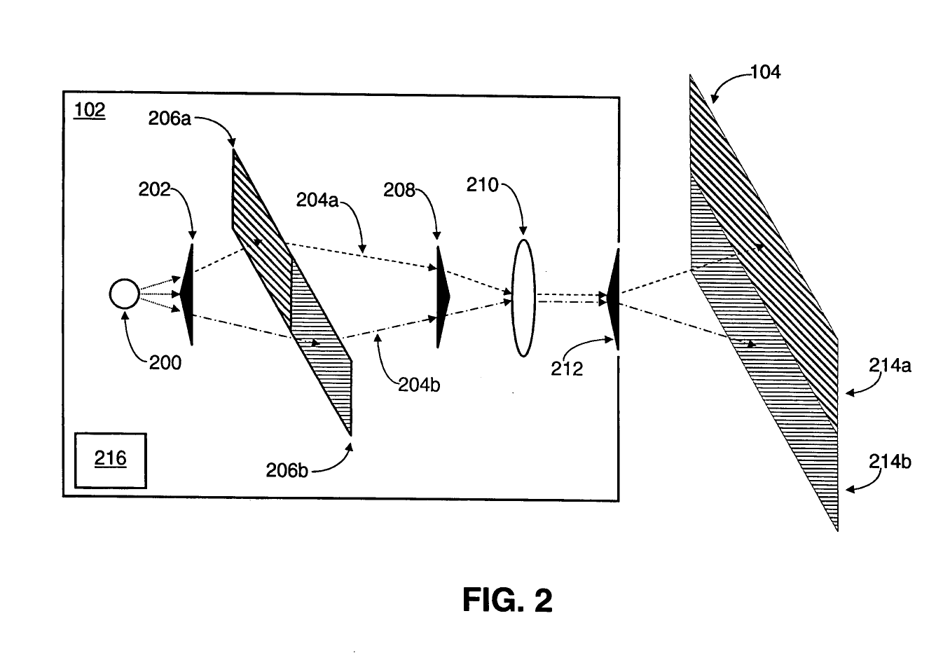

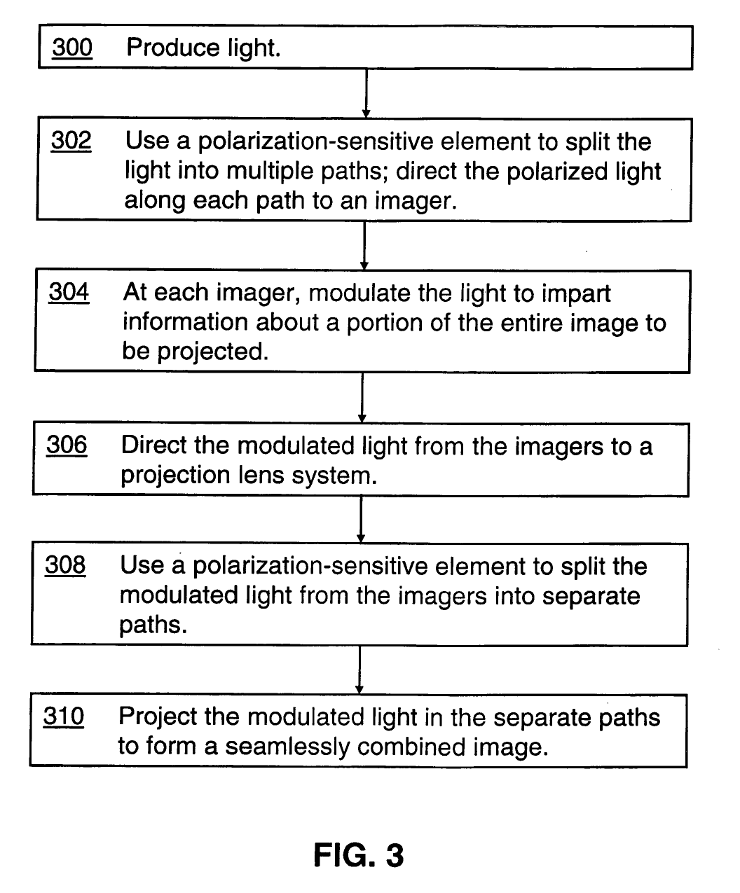

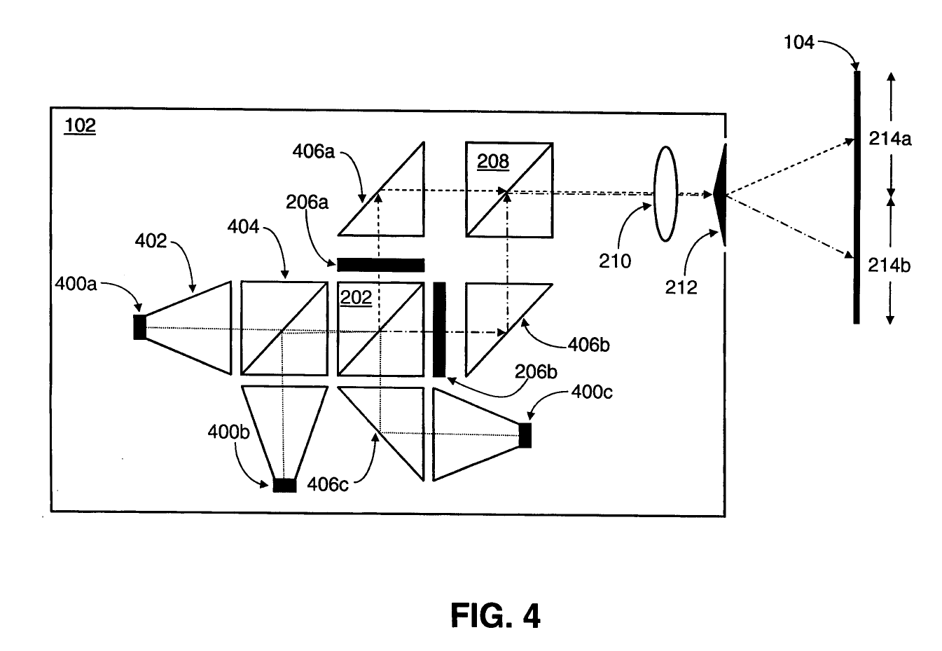

FIG. 2 gives an example of how a microprojector made according to aspects of the present invention can achieve a high resolution in the projected image 104. FIG. 3 also illustrates embodiments of the present invention by following the light through the microprojector system. An illumination source 200 (discussed in greater detail below in reference to FIG. 4) produces light (Step 300 of FIG. 3). A first polarization-sensitive element 202 splits the into multiple paths 204a and 204b (Step 302), one path 204a directed toward a first imager 206a, and the other path 204b directed toward a second imager 206b.

Typical imagers 206a and 206b are liquid-crystal devices that require polarized light. Because illumination systems typically produce unpolarized light, many previous systems filter their generated light through a polarizer before directing it to an imager. This technique, however, throws away all of the incipient light whose polarization is not aligned with that of the polarizer. This results in a loss of about 50% of the original light. In the system of FIG. 2, on the other hand, the first polarization-sensitive element 202 uses all of the light directed to it, either in the beam 204a directed toward the first imager 206a or in the other beam 204b directed toward the other imager 206b.

By modulating the polarized light transmitted to it, each imager 206a and 206b generates a portion of what will be the overall projected image 104 (Step 304 of FIG. 3). The light modulated by the imagers 206a and 206b is directed by a second polarization-sensitive element 208 toward a projection lens system 210 (Step 306). Because the light modulated by the first imager 206a has a polarization different from that of the light modulated by the other imager 206b, a third polarization-sensitive element 212 can separate and position the image portions created by the imagers 206a and 206b (Step 308). When these image portions are projected by the projection lens system 210 (Step 310), they become the projected image portions 214a and 214b which seamlessly combine into the overall image 104.

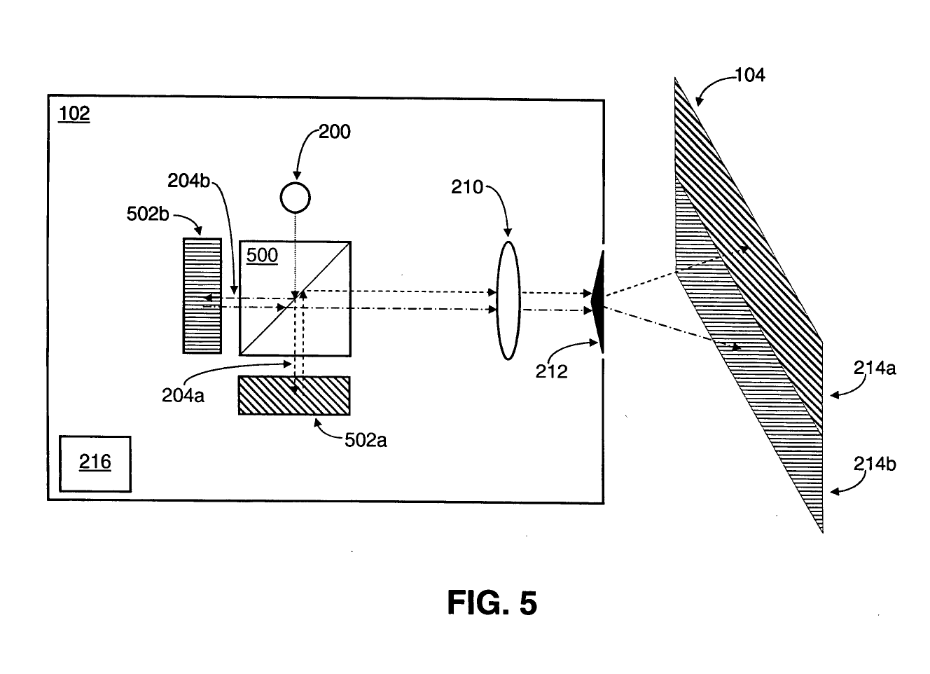

For simplicity's sake, the projection lens system 210 is drawn as a single lens in FIG. 2 (and in FIGS. 4 and 5). As is well known in the art, a projection lens system 210 can include numerous lenses of different curvatures and materials. In some embodiments, the third polarization-sensitive element 212 is placed at the aperture stop of the projection lens system 210. While FIG. 2 shows the third polarization-sensitive element 212 located after the projection lens system 210, in other embodiments the third polarization-sensitive element 212 can be placed either before or within the projection lens system 210. While different projection lens systems 210 and different placements of the third polarization-sensitive element 212 are chosen based on physical constraints and on anticipated use, it is preferred that the choice of these two elements 210 and 212 be made together. In order to make the image portions 214a and 214b correctly tile to form the final image 104 without seam or overlap, it is recommended that the deflecting angle of the third polarization-sensitive element 212 be matched to the shooting angle of the projection lens system 210.

In different embodiments, different technologies can be used for the polarization-sensitive elements 202, 208, and 210. For a few examples, they can be polarizing beamsplitters, calcite-crystals, liquid-crystal-type cells, thin-film polarization-sensitive elements, Wollaston prisms, or some combination of these.

The illustrative implementation of FIG. 2 shows the imagers 206a and 206b as two physically separate entities. In some implementations, however, these logically separate imagers can be embodied in one physical entity, called here a “combined imager” to distinguish it from traditional monolithic imagers. A combined imager operating according to aspects of the present invention would operate in a manner similar to the manner discussed here for the separate imagers 206a and 206b. For example, a combined imager could be “long and thin” as suggested by FIG. 2 when compared to a traditional monolithic imager with the same overall resolution. Also for example, a left section of the combined imager works with light of one polarization state and creates the image portion 214a, while a right section of the combined imager works with light of another polarization state and creates the image portion 214b.

While the portions 214a and 214b of the final image 104 are stacked vertically in FIG. 2, FIG. 2 shows that the imagers 206a and 206b need not be stacked vertically but can reside side-by-side within the personal portable device 102. This side-by-side layout of the imagers 206a and 206b, each shorter in a vertical direction than a monolithic imager of the same overall resolution, permits the personal portable device 102 to remain small and thin.

The personal portable device 102 of FIG. 2 also includes controller logic and image memory 216. As directed by a user, the controller 216 retrieves image information and directs it to the imagers 206a and 206b for display. As the controller logic and image memory 216 are well known in the art, they are not further discussed here.

Because the final projected image 104 is produced by multiple imagers 206a and 206b, there is no need to include in the personal portable device 102 room for a single monolithic imager that has the same resolution as the final image 104. Instead, the system of FIG. 2 is arranged in such a way that the resolution of the final image 104 is the sum of the resolutions of the individual imagers 206a and 206b. If exactly two imagers are used in the system of FIG. 2, and if each imager 206a and 206b has a horizontal resolution equal to the horizontal resolution of the overall image 104, and if each imager 206a and 206b has half the vertical resolution of the overall image 104, then these two imagers 206a and 206b can, in combination, produce the total resolution of the overall image 104. In this case, the thickness of the personal portable device 102 is constrained only by the vertical dimension of the “half-height” imagers 206a and 206b rather than by the vertical dimension of a “full-height” monolithic imager.

Note again that “vertical” and “horizontal” are used here merely for convenience' sake and are used with respect to the figure under discussion. In most embodiments, the image 104 is expected to be projected from an end face of the personal portable device 102. The shape of the end face of many personal portable devices 102 approximates a long, thin rectangle. In some embodiments of the present invention, the projected image 104 roughly follows this shape. Thus, to project an image in “landscape” mode (that is, with a greater horizontal than a vertical dimension), the user 100 holds her personal portable device 102 “flat” (with the long edge of the face of the device 102 parallel to the ground). To project an image 104 in the “portrait” mode as shown in FIG. 1, the user 100 turns her personal portable device 102 so that the long edge of its end face is vertical. Known technology can be used to tell the personal portable device 102 of its orientation so that it can project the image 104 appropriately.

FIG. 4 shows how embodiments of the present invention double the lighting efficiency of many previous devices. The illumination system here includes three light sources 400a, 400b, and 400c. Each source 400a, 400b, and 400c produces unpolarized light of one color, while the combination of sources usefully covers the visible spectrum (e.g., one source produces red light, one green, and one blue). In some embodiments, each source 400a, 400b, and 400c is a light-emitting diode. Light from the three monochromatic sources 400a, 400b, and 400c is directed, possibly via light tunnels such as 402, and combined together. In the example of FIG. 4, two colors are first combined in a dichroic beamsplitter 404, and then the combination of the two colors is combined with the third color in the first polarization-sensitive element 202. Two polarized light beams leave the first polarization-sensitive element 202, one directed toward the first imager 206a, and the other directed toward another imager 206b. Each polarized beam leaving the first polarization-sensitive element 202 includes light of all three colors.

As discussed above in relation to FIG. 2, the imagers 206a and 206b modulate the light directed through them to imprint the light with portions of the final image 104. Depending upon the physical layout of the components, the modulated light may be directed by total-internal-reflective prisms 406a and 406b as it travels to the second polarization-sensitive element 208. The second polarization-sensitive element 208 combines the paths of the polarized light and directs all of the light to the projection lens system 210 and third polarization-sensitive element 212.

By using essentially all of the light produced by the sources 400a, 400b, and 400c, the embodiment of FIG. 4 is approximately twice as light- and power-efficient as previous systems. In response to specific packaging and other constraints, known optical techniques can be used to rearrange the components of FIG. 4 without departing from the teachings of the present invention.

The imagers 206a and 206b shown in FIG. 2 are called “transmissive” imagers because they modulate light as it passes through them. “Reflective” imagers are also known and can be used in embodiments of the present invention. These imagers modulate light as it reflects off of them. FIG. 5 presents an embodiment of the present invention that uses reflective imagers. Light from the illumination source 200 is directed to a first polarization-sensitive element 500 which splits the light into multiple polarized paths 204a and 204b. The polarized light is directed to the two reflective imagers 502a and 502b. These imagers 502a and 502b impart image information into the light as it reflects off of them directly back to the first polarization-sensitive element 500. That element 500 directs the light from both polarized light paths 204a and 204b toward the projection lens system 210 and the third polarization-sensitive element 212, as in FIG. 2. In effect, this polarization-sensitive element 500 does the work of both the first and the second polarization-sensitive elements 202 and 208 of FIG. 2. The choice to use reflective or transmissive imagers is based on packaging and other considerations.

FIG. 2, 4, and 5 show how the use of polarized light allows the imagers 206a and 206b (or 502a and 502b) to each have a vertical dimension approximately equal to that of the projection lens system 210. As shown in FIGS. 2, 4, and 5, the individual half-height imagers are not stacked on top of one another, but can be placed in some kind of side-by-side arrangement. Thus, the use of polarized light enables the increased resolution provided by the multiple imagers without increasing the thickness of the personal portable device 102.

In view of the many possible embodiments to which the principles of the present invention may be applied, it should be recognized that the embodiments described herein with respect to the drawing figures are meant to be illustrative only and should not be taken as limiting the scope of the invention. For example, the light paths in the figures are only meant to illustrate the functions of the various components and are not meant to be definitive. Other arrangements of the optical components shown in the figures and the addition of other known optical components are possible and may be called for in various environments. Therefore, the invention as described herein contemplates all such embodiments as may come within the scope of the following claims and equivalents thereof.

We claim:

1. An image projector comprising:
an illumination system;
a first polarization-sensitive element configured for splitting light from the illumination system and for directing the light along paths toward each of a plurality of imagers;
the plurality of imagers, each imager configured for modulating light in a light path;
a second polarization-sensitive element configured for directing the modulated light from the imagers toward a projection lens system;
a third polarization-sensitive element configured for separating the modulated light from the imagers; and
the projection lens system configured for projecting the modulated light, the projected modulated light producing a combined image.

2. The image projector of claim 1 wherein the illumination system comprises a plurality of monochromatic light sources.

3. The image projector of claim 2 wherein each monochromatic light source is selected from the group consisting of: a light-emitting diode and a laser.

4. The image projector of claim 1 wherein the illumination system comprises a white-light source.

5. The image projector of claim 1 comprising exactly two imagers.

6. The image projector of claim 1 wherein a resolution of the combined image is a sum of resolutions of the imagers.

7. The image projector of claim 6 wherein the resolution of the combined image is a product of a horizontal resolution of the combined image and a vertical resolution of the combined image, wherein the horizontal resolution of the combined image equals a horizontal resolution of each imager, and wherein the vertical resolution of the combined image equals a sum of vertical resolutions of the imagers.

8. The image projector of claim 1 wherein the third polarization-sensitive element is located at an aperture stop of the projection lens system.

9. The image projector of claim 8 wherein a location of each polarization-sensitive element with respect to the projection lens system is selected from the group consisting of: before the projection lens system, after the projection lens system, and within the projection lens system.

10. The image projector of claim 1 wherein the third polarization-sensitive element is selected from the group consisting of: a polarizing beamsplitter, a calcite-crystal polarization-sensitive element, a liquid-crystal-type cell, a thin-film polarization-sensitive element, and a Wollaston prism.

11. The image projector of claim 1 wherein each imager is a transmissive imager.

12. The image projector of claim 1 wherein each imager is a reflective imager, and wherein the first and second polarization-sensitive elements are combined into one polarization-sensitive element.

13. A method for projecting an image, the method comprising:
producing light;
splitting the light into a plurality of polarized light paths;
for each of the plurality of polarized light paths, using an imager to modulate the light in the polarized light path;
directing the modulated light in the polarized light paths toward a projection lens system;
separating the modulated light into a plurality of polarized light paths; and
projecting the modulated light, the projected modulated light producing a combined image.

14. The method of claim 13 wherein splitting the light comprises splitting the light into exactly two light paths.

15. The method of claim 13 wherein modulating the light comprises transmitting light through an imager.

16. The method of claim 13 wherein modulating the light comprises reflecting light off an imager.

17. The method of claim 13 wherein a resolution of the combined image is a sum of resolutions of the imagers.

18. The method of claim 17 wherein the resolution of the combined image is a product of a horizontal resolution of the combined image and a vertical resolution of the combined image, wherein the horizontal resolution of the combined image equals a horizontal resolution of each imager, and wherein the vertical resolution of the combined image equals a sum of vertical resolutions of the imagers.

19. A personal portable device, the device comprising:
a memory configured for storing image information; and
an image projector, the image projector comprising:
an illumination system;
a first polarization-sensitive element configured for splitting light from the illumination system and for directing the light along paths toward each of a plurality of imagers;
the plurality of imagers, each imager configured for modulating light in a light path;
a second polarization-sensitive element configured for directing the modulated light from the imagers toward a projection lens system;
a third polarization-sensitive element configured for separating the modulated light from the imagers; and
the projection lens system configured for projecting the modulated light, the projected modulated light producing a combined image.

20. The personal portable device of claim 19 wherein the device is selected from the group consisting of: a cellular telephone, a personal digital assistant, and a personal computer.
